(19) United States
(12) Patent Application Publication
(10) Pub. No.: US 2025/0140876 A1
(43) Pub. Date: May 1, 2025

(54) SOLID OXIDE CELL AND MANUFACTURING METHOD THEREOF

(71) Applicant: SAMSUNG ELECTRO-MECHANICS CO., LTD., Suwon-si, Gyeonggi-do (KR)

(72) Inventors: Dongjin Kim, Suwon-si, Gyeonggi-do (KR); Byungchul Jang, Suwon-si, Gyeonggi-do (KR); Subeom Park, Suwon-si, Gyeonggi-do (KR); Hyegsoon An, Suwon-si, Gyeonggi-do (KR); Jaeseok Yi, Suwon-si, Gyeonggi-do (KR); Hongryul Lee, Suwon-si, Gyeonggi-do (KR); Areum Jun, Suwon-si, Gyeonggi-do (KR); Shiwoo Lee, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/571,590

(22) PCT Filed: Nov. 10, 2023
(86) PCT No.: PCT/KR2023/018061

§ 371 Date: Dec. 18, 2023

(30) Foreign Application Priority Data
Nov. 24, 2022 (KR) 10-2022-0159244
Apr. 19, 2023 (KR) 10-2023-0051468

(51) Int. Cl. H01M 4/90; C25B 11/091; C25B 13/07; H01M 4/86; H01M 4/88; H01M 8/12; H01M 8/1213; H01M 8/1253

(52) U.S. Cl. CPC H01M 4/9025; C25B 11/091; C25B 13/07; H01M 4/8657; H01M 4/8663; H01M 4/8857; H01M 4/8885; H01M 4/905; H01M 8/1213; H01M 8/1253; H01M 2004/8684; H01M 2008/1293

(57) ABSTRACT

A solid oxide cell includes a solid oxide electrolyte, and a fuel electrode disposed on one side of the solid oxide electrolyte and an air electrode disposed on the other side thereof. The fuel electrode includes alloy oxide particles of nickel (Ni) and a heterogeneous metal alloyable therewith and a solid oxide electrolyte material, and when an atomic percentage (at %) of the heterogeneous metal to all atoms in a center region of the alloy oxide particle is M_{core} and an atomic percentage (at %) of the heterogeneous metal to all atoms in a surface region of the alloy particle is M_{surface} 10×M_{core}<M_{surface}.

### TECHNICAL FIELD

This application claims priority to and the benefit of Korean Patent Application No. 10-2022-0159244 filed in the Korean Intellectual Property Office on Nov. 24, 2022, and Korean Patent Application No. 10-2023-0051468 filed in the Korean Intellectual Property Office on Apr. 19, 2023, the entire contents of which are in-corporated herein by reference.

This disclosure relates to a solid oxide cell and a method of manufacturing the same.

### BACKGROUND ART

A solid oxide cell (SOC) is for example a solid oxide fuel cell (SOFC) or a solid oxide electrolyzer cell (SOEC) and generate electrical energy through an electrochemical reaction of a cell composed of an air electrode, a fuel electrode a solid oxide electrolyte having oxygen ionic conductivity or electrolyze water and generate hydrogen through a reverse reaction of the solid oxide fuel cell.

The solid oxide cell has a configuration of disposing the air electrode and the fuel electrode on both sides of the solid oxide electrolyte having oxygen ionic conductivity to respectively supply air and hydrogen through flow paths formed in a separator to the air electrode and the fuel electrode and thus generate electricity or bring about an elec-trolysis through an electrochemical reaction.

The solid oxide cell operates at a high temperature of 800° C. or higher. Accordingly, the solid oxide cell has high activity, unlike a polymer electrolyte fuel cell, which is a low-temperature fuel cell, using a highly active but expensive catalyst such as platinum, and thus may use an inexpensive catalyst such as nickel. The better performance the fuel electrode has, the higher density of a three-phase boundary (TPB) where the nickel, a solid oxide, and gas meet, which is enhanced by the nickel evenly and widely spread within the solid oxide after the firing.

However, when nickel constituting about 40% of the volume of the fuel electrode meets and aggregates each other under high-temperature operating conditions and is exposed to oxidation and reduction processes due to repeated stop and restait, the nickel may expand and contract, leading to destruction of the entire structure of the solid oxide cell.

### DISCLOSURE OF INVENTION

### Technical Problem

According to the solid oxide cell according to one aspect, by delaying a contraction of nickel (Ni) during firing of the fuel electrode so that it is widely distributed without aggregation, a density of the three-phase boundary is increased to improve performance and by preventing deterioration occurring during fuel electrode operation, durability may be increased.

### Solution to Problem

A solid oxide cell according to one aspect includes a solid oxide electrolyte, and a fuel electrode disposed on one side of the solid oxide electrolyte and an air electrode disposed on the other side thereof. The fuel electrode includes an alloy oxide particle of nickel (Ni) and a heterogeneous metal alloyable therewith, and a solid oxide electrolyte material.

When an atomic percentage (at %) of the heterogeneous metal to all atoms in a center region of the alloy oxide particle is M_{core}, and an atomic percentage (at %) of the heterogeneous metal to all atoms in a surface region of the alloy particle is M_{surface}, 10×M_{core}<M_{surface}.

The M_{core} may be the atomic percentage (at %) of the heterogeneous metal measured within the center region centered on a center of the alloy oxide particle and having dimensions of 10 nm×10 nm.

The M_{surface} may be the atomic percentage (at %) of the heterogeneous metal measured within the surface region having dimensions of 2 nm×2 nm, centered on an internal point within 20 nm from a surface toward the center of the alloy oxide particle.

In the center region of the alloy oxide particle, the heterogeneous metal may be included in an amount of greater than or equal to 0.01 at % and less than 1 at % based on the total atoms.

On the surface region of the alloy oxide particle, the heterogeneous metal may be included in an amount of greater than or equal to 0.1 at % and less than 10 at % based on the total atoms.

The heterogeneous metal may include tin (Sn), indium (In), bismuth (Bi), gallium (Ga), or a combination thereof.

The solid oxide electrolyte material may include an yttria-stabilized zirconia (YSZ), a scandia-stabilized zirconia (SeSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

The solid oxide electrolyte may include an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

The air electrode may include a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

The solid oxide cell may be a solid oxide fuel cell (SOFC), a solid oxide electrolyzer cell (SOEC), or both.

A method of manufacturing a solid oxide cell according to another aspect includes coating a surface of a nickel oxide (NiO) particle with a heterogeneous metal alloyable therewith, and forming a fuel electrode using a composition for forming a fuel electrode including the nickel oxide particle coated with the heterogeneous metal.

The coating of the heterogeneous metal on the surface of the nickel oxide (NiO) particle may use a sputtering method, an atomic layer deposition (ALD) method, a physical vapor deposition (PVD) method, or a chemical vapor deposition method (CVD) method.

The composition for forming the fuel electrode may further include a solid oxide electrolyte material.

The forming of the fuel electrode may include casting and firing the composition for forming the fuel electrode.

A solid oxide cell according to one aspect includes a solid oxide electrolyte, and a fuel electrode disposed on one side of the solid oxide electrolyte and an air electrode disposed on the other side thereof. The fuel electrode includes a solid oxide electrolyte material, and an alloy oxide particle of nickel (Ni) and a heterogeneous metal alloyable therewith disposed mainly in a surface region of the alloy oxide particle of nickel (Ni). The heterogeneous metal includes tin (Sn), indium (in), bismuth (Bi), gallium (Ga), or a combination thereof.

The surface region of the alloy oxide particle of nickel (Ni) may be a region having dimensions of 2 nm×2 nm, centered on an internal point within 20 nm from a surface toward a center of the alloy oxide particle of nickel (Ni).

at % of the heterogeneous metal to all atoms in the surface region of the alloy oxide particle may be 19 times or higher at % of the heterogeneous metal to all atoms at a center region of the alloy oxide particle.

### Advantageous Effects of Invention

According to the solid oxide cell according to one aspect, by delaying a contraction of nickel (Ni) during firing of the fuel electrode so that it is widely distributed without aggregation, a density of the three-phase boundary is increased to improve performance and by preventing deterioration occurring during fuel electrode operation, durability may be increased.

### BRIEF DESCRIPTION OF DRAWINGS

FIG. 1 is a schematic view schematically illustrating a cross section of a solid oxide cell according to one aspect.

FIG. 2 is a schematic view illustrating a solid oxide fuel cell according to a modified embodiment of one aspect.

FIG. 3 is a schematic view illustrating a solid oxide electrolyzer cell according to another modified embodiment of one aspect.

FIG. 4 is a HAADF phase of alloy oxide particles.

FIG. 5 is an EDS mapping result for nickel (Ni).

FIG. 6 is an EDS mapping result for tin (Sn).

FIG. 7 is a scanning electron microscope (SEM) photograph of the fuel electrode in the solid oxide cell manufactured in Example 1.

FIG. 8 is a scanning electron microscope (SEM) photograph of a fuel electrode in a solid oxide cell manufactured in Comparative Example 1.

FIG. 9 is a graph showing the results of measuring the size distribution of alloy oxide particles in FIG. 7 and the size distribution of nickel oxide particles in FIG. 8.

FIG. 10 is a graph showing results of measuring acceleration durability of the solid oxide cells prepared in Example 1 and Comparative Example 1.

### MODE FOR THE INVENTION

Hereinafter, with reference to the accompanying drawings, the present invention will be described in detail so as to facilitate practice by one having ordinary skill in the art to which it belongs. The drawings and description am to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some components are exaggerated, omitted, or schematically depicted in the accompanying drawings, and the dimensions of each component are not necessarily indicative of actual dimensions.

In addition, unless explicitly described to the contrary, the word “comprise”, and variations such as “comprises” or “comprising”, will be understood to imply the inclusion of stated elements but not the exclusion of any other elements.

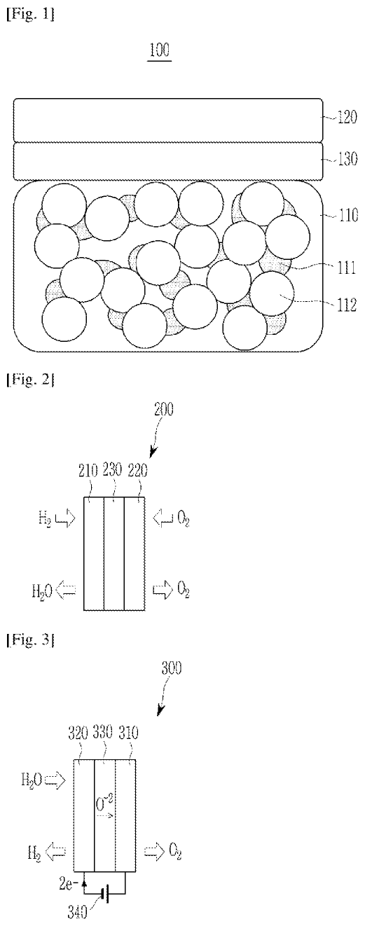

FIG. 1 is a schematic view schematically illustrating a cross section of a solid oxide ccl 100 according to one aspect.

Referring to FIG. 1, the solid oxide cell 100 includes a solid oxide electrolyte 130, a fuel electrode 110 disposed on one side of the solid oxide electrolyte 130, and an air electrode 120 disposed on the other side thereof.

The fuel electrode 110 serves to electrochemically oxidize fuel and transfer charges.

The fuel electrode 110 includes alloy oxide particles 111 of nickel (Ni) and a heterogeneous metal alloyable therewith, and a solid oxide electrolyte material 112.

The performance of the fuel electrode 110 is better as the density of the three-phase boundary (TPB) where nickel, the solid oxide electrolyte material 112, and the gas meet is higher, which means that it is advantageous as the nickel spreads evenly and widely within the solid oxide electrolyte material 112 after firing.

However, when nickel constituting about 40% of the volume of the fuel electrode 110 meets and aggregates each other under high-temperature operating conditions and is exposed to oxidation and reduction processes due to repeated stop and restart, the nickel may expand and contract, leading to destruction of the entire structure of the solid oxide cell 100.

In the solid oxide cell 100 according to one aspect, when an atomic percentage (at %) of the heterogeneous metal to all atoms in a center region of the alloy oxide particle is M_{core}, and an atomic percentage (at %) of the hetemgencous metal to all atoms in a surface region of the alloy particle is M_{surface}, 10×M_{core}<M_{surface}, the fuel electrode 110 includes alloy oxide particles 111 of nickel (Ni) and a heterogeneous metal and satisfying 10×M_{core}<M_{surface}.

Herein, the solid oxide cell 100 may have a first direction, in which the fuel electrode 110, the solid oxide electrolyte 130, and the air electrode 120 are stacked, and a second direction and a third direction perpendicular to the first direction and also, perpendicular to each other, wherein at % of a specific atom to all atoms in the center region or the surface region of the alloy oxide particle 111 may be analyzed by examining a reflection electron image of a cross-section of the solid oxide cell 100, cut at the center of the second direction, in the first direction and the third direction perpendicular to the second direction with a scanning electron microscope (SEM) or a HAADF image thereof with a scanning transmission electron microscope (STEM), etc.

For example, at % of the specific atom according to a position of the alloy oxide particle 111 may be measured through a component analysis by using an electron beam microanalyzer (EPMA) in the reflection electron image of SEM or the HAADF image of STEM. The component analysis may be performed by obtaining measurements at at least 3, 5, or 10 or mom locations and calculating an average of the measurements to calculate a composition. When the electron beam microanalyzer (EPMA) is used to perform the component analysis and the like, EDS (energy dispersive spectroscope), WDS (wavelength dispersive spectroscope), or the like may be used as an X-ray spectroscope.

Or, when the reflection electron image of SEM or the HAADF image of STEM is used to examine the alloy oxide particle 111, the nickel and the heterogenous metal having a metallic bond may be recognized as a bright part of contrast, while non-metal components such as oxygen and the like may be recognized as a dark part of the contrast. Accordingly, the at % of the specific atom according to a location of the alloy oxide particle 111 may be calculated as an area ratio of the bright part of the contrast to the entire measurement field of view by binarizing the cross-section image and the like. In addition, the measurement is performed at least 3, 5, or 10 or more alloy oxide particles 111, whose measurements are calculated into an average.

Herein, the center of the alloy oxide particle 111 may be determined as a point where the maximum major axis of the alloy oxide particle 111 meets the maximum minor axis among minor axes perpendicular to the maximum major axis, and the surface of the alloy oxide particle 111 may be determined as one of the points where the outermost of the alloy oxide particle 111 meets the maximum major axis.

When the alloy oxide particle 111 satisfies 10×M_{core}<M_{surface}, that is, the surface of the alloy oxide particle 111 includes a region with a high content of the heterogeneous metal. Ni is not aggregated due to delayed shrinkage of the nickel (Ni) but widely distributed during the firing of the fuel electrode 110. Through this, density of the three-phase boundary of the fuel electrode 110 may be increased. In addition, a nickel alloy coated as a region having a high content of the heterogeneous metal may prevent deterioration due to aggregation of the nickel during operation of the solid oxide cell 100, thereby increasing durability.

For example, when an atomic percentage (at %) of the heterogeneous metal to all atoms in a center region of the alloy oxide particle 111 is M_{core}, and an atomic percentage (at %) of the heterogeneous metal to all atoms in a surface region of the alloy particle 111 is M_{surface}, 10×M_{core}<M_{surface}.

The surface region with a high content of the heterogeneous metal is located close to the outermost surface of the alloy oxide particle 111 and satisfies 10×M_{core}<M_{surface}.

Herein, M_{core} may be at % of the heterogeneous metal measured within the center region centered on the center of the alloy oxide particle 111 and having dimensions of 10 nm×10 nm.

M_{surface} may be at % of the heterogeneous metal measured within the surface region having dimensions of 2 nm×2 nm, centered on any internal point within 20 nm from the surface toward the center of the alloy oxide particle 111. For example, M_{surface} may be at % of the heterogeneous metal measured within the surface region having dimensions of 2 nm×2 nm, centered on any internal point 20 nm apart.

For example, in the center region of the alloy oxide particle 111, the heterogeneous metal may be included in an amount of greater than or equal to 0.01 at % and less than 1 at % based on all the atoms. In the center region of the alloy oxide particle 111, when the content of the heterogeneous metal is greater than or equal to 1 at %, resistance may increase, deteriorating performance, but when the content of the heterogeneous metal is less than 0.01 at %, there may be an insignificant effect of the heterogeneous metal.

In addition, in the surface region of the alloy oxide particle 111, the heterogeneous metal may be included in an amount of greater than or equal to 0.1 at % and less than 10 at % based on all the atoms. Herein, in the surface region of the alloy oxide particle 111, at % of the heterogeneous metal measured within a surface region having dimensions of 2 nm×2 nm, centered on any internal point within 20 nm from the surface toward the center of the alloy oxide particle 111.

The heterogeneous metal is not particularly limited as long as it can be reduced and form an alloy with nickel, but it is more desirable if it is a metal that can be more distributed in the particle surface region after alloying. For example, the heterogeneous metal may include tin (Sn), indium (In), bismuth (Bi), gallium (Ga), or a combination thereof.

The alloy oxide particles 111 may include a region having a high heterogeneous metal content in the surface region, thereby delaying contraction of nickel (Ni) during firing of the fuel electrode 110 and preventing aggregation.

The solid oxide electrolyte material 112 should have high oxygen ionic conductivity and low electronic conductivity.

For example, the solid oxide electrolyte material 112 may include an yttria-stabilized zirconia (YSZ), a scandia-stabilized zinconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

In this case, the fuel electrode 110 may include cermet in which the alloy oxide particles 111 and the solid oxide electrolyte material 112 are combined. For example, when the alloy oxide particles 111 include an alloy of nickel (Ni) and tin (Sn) and the solid oxide electrolyte material 112 is yttria stabilized zirconia (YSZ), the fuel electrode 110 includes Ni—Sn/YSZ cermet.

For example, a thickness of the fuel electrode 110 may be, for example, 1 μm to 1000 μm, or 5 μm to 100 μm.

The air electrode 120 includes an air electrode material. The air electrode material may be a material that reduces oxygen gas into oxygen ions.

For example, the air electrode material may include metal oxide particles having a perovskite-type crystal structure. The perovskite-type metal oxide is a mixed ionic and electronic conductor (MIEC) material having both ionic and electronic conductivity, and have a high oxygen diffusion coefficient and a charge exchange reaction rate coefficient, allowing an oxygen reduction reaction to occur on the entire surface of the electrode, not just at the three-phase boundary.

The perovskite-type metal oxide may be represented by Chemical Formula 1.

ABO_{3±γ} [Chemical Formula 1]

In Chemical Formula 1, A is an element including La, Ba, Sr, Sm. Gd, Ca. or a com-hination thereof, B is an element including Mn, Fe, Co, Ni. Cu, Ti. Nb. Cr. Sc, or a combination thereof, and γ indicates an oxygen excess or deficiency. The γ may be for example, in the range of 0≤γ≤0.3.

For example, the perovskite-type metal oxide may be represented by Chemical Formula 2.

A′₁₋ₓA″ₓB′O_{3±γ} [Chemical Formula 2]

In Chemical Formula 2. A′ is an element including Ba, La, Sm, or a combination thereof, A″ is an element including Sr, Ca, Ba. or a combination thereof and is different from A′, B′ is an element including Mn, Fe, Co, Ni, Cu, Ti, Nb, Cr, Sc. or a combination thereof, 0≤x<1, and γ indicates an oxygen excess or deficiency.

For example, the air electrode material may include a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

The air electrode may further include a solid oxide electrolyte material.

For example, the solid oxide electrolyte material may include an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

In this case, when the solid oxide electrolyte material is yttria-stabilized zirconia (YSZ) and the air electrode material is lanthanum-strontium manganese oxide (LSM), the porous solid oxide composite may be an LSM-YSZ composite.

The air electrode 120 may, for example, have a thickness of about 1 μm to about 100 μm or about 5 μm to about 50 μm.

The solid oxide electrolyte 130 plays a role of transporting the oxygen ions generated from the air electrode 120 to the fuel electrode 110 through ion conduction. The solid oxide electrolyte 130 may have gas impermeability to block a contact between air and the fuel electrode 110 and also block the electrons generated at the fuel electrode 110 from directly moving toward the air electrode 120 due to high oxygen ionic conductivity and low electronic conductivity (high electrical resistance, high insulation).

In addition, since the solid oxide electrolyte 130 has the air electrode 120 and the fuel electrode 110, which have a very large oxygen partial pressure, on both sides thereof, the aforementioned properties may be necessary to maintain in a wide oxygen partial pressure region.

The materials of these solid oxide electrolyte 130 is not particularly limited as long as they are generally available in the art, and may include, for example, an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a sanaria- and ceria-doped barium cerate (BaCeO₃), or a combination thereof.

A thickness of the solid oxide electrolyte 130 may be, for example, 10 nm to 100 μm, or 100 nm to 50 μm.

Optionally, the solid oxide cell 100 may further include an electrical collecting layer (not shown) including an electrical conductor on at least one side of the air electrode 120, for example an outer side of the air electrode 120. The electrical collecting layer may act as a current collector to collect electricity in configurations of the air electrode 120.

The electrical collecting layer may include, for example, a lanthanum cobalt oxide (LaCoO₃), a lanthanum strontium cobalt oxide (LSC), a lanthanum strontium cobalt iron oxide (LSCF), a lanthanum strontium cobalt manganese oxide (LSCM), a lanthanum strontium manganese oxide (LSM), a lanthanum strontium iron oxide (LSF), or a combination thereof. The electrical collecting layer may use the above-listed materials alone or in a combination of two or more, wherein these materials may be formed into a single layer or two or more layers with a stacked structure.

The solid oxide cell 100 may be applied to various structures such as a cylindrical (tubular) stack, a flat tubular stack, a planar-type stack, and the like.

In addition, the solid oxide cell 100 may be in the form of a stack of unit cells. For example, the unit cells (Membrane and Electrode Assembly (MEA)) composed of the air electrode 120, the fuel electrode 110, and the solid oxide electrolyte 130 are stacked in series, and separators electrically connected between the unit cells are disposed, obtaining the stack of the unit cells.

For example, the solid oxide cell may be a solid oxide fuel cell (SOFC), a solid oxide electrolyzer cell (SOEC), or both.

FIG. 2 is a schematic view illustrating a case in which the solid oxide cell 100 is the solid oxide fuel cell.

Referring to FIG. 2, the solid oxide fuel cell 200 includes a fuel electrode 210, an air electrode 220 facing the fuel electrode 210, and an oxygen ion conductive solid oxide electrolyte 230 between the fuel electrode 210 and the air electrode 220.

As shown in Reaction Scheme 1, an electrochemical reaction of the solid oxide fuel cell 200 includes an air electrode reaction in which oxygen gas O₂ of the air electrode 220 is converted into oxygen ions O₂ and a fuel electrode reaction in which a fuel (H₂ or hydrocarbon) of the fuel electrode 210 reacts with oxygen ions that have moved through the electrolyte.

Air electrode reaction: ½O₂+2e−→O₂⁻

Fuel electrode reaction: H₂+O₂⁻→H₂O+2e⁻ [Reaction Scheme 1]

In the air electrode 220 of the solid oxide fuel cell 200, the oxygen adsorbed into the electrode surface is dissociated and moves through surface diffusion to the three-phase boundary (triple phase boundary) where the solid oxide electrolyte 230, the air electrode 220, and pores (not shown) meet to gain electrons into oxygen ions, and the produced oxygen ions move toward the fuel electrode 210 through the solid oxide electrolyte 230.

In the fuel electrode 210 of the solid oxide fuel cell 200, the moved oxygen ions are combined with hydrogen contained in the fuel to generate water. At this time, the hydrogen discharges the electrons to be hydrogen ions (H⁺) which combine with the oxygen ions. The discharged electrons move to the air electrode 220 through a wire (not shown) and change oxygen into oxygen ions. Through this movement of electrons, the solid oxide fuel cell 200 can perform a battery function.

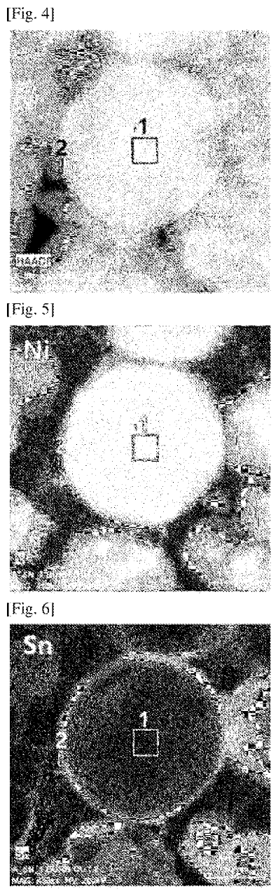

FIG. 3 is a schematic view illustrating a case in which the solid oxide cell 100 is the solid oxide electrolyzer cell.

Referring to FIG. 3, the solid oxide electrolyzer cell 300 includes an air electrode 310, a fuel electrode 320 disposed facing the air electrode 310, and an oxygen ion conductive solid oxide electrolyte 330 disposed between the air electrode 310 and the fuel electrode 320.

As shown in Reaction Scheme 2, an electrochemical reaction of the solid oxide electrolyzer cell 300 includes a fuel electrode reaction in which water (H₂O) of the fuel electrode 320 is changed into hydrogen gas (H₂) and oxygen ions (O₂⁻) and an air electrode reaction in which the oxygen ions moved through the solid oxide electrolyte 330 are changed into oxygen gas (O₂). This reaction is contrary to reaction principles of a conventional fuel cell.

Fuel electrode reaction: H₂O+2e→O₂⁻+H₂

Air electrode reaction: O₂⁻→½O₂+2e⁻ [Reaction Scheme 2]

When electric power is applied to the solid oxide electrolyzer cell 300 from an external power source 340, the solid oxide electrolyzer cell 300 is supplied with electrons from the external power source 340. The electrons react with water supplied to the fuel electrode 320 to generate the hydrogen gas and the oxygen ions. The hydrogen gas is discharged to the outside, and the oxygen ions pass through the electrolyte 330 to the air electrode 310. The oxygen ions moved to the air electrode 310 lose electrons and then, are changed into oxygen gas and discharged to the outside. The electrons flow to the external power source 340. Through this electron movement, the solid oxide electrolyzer cell 300 may electrolyze the water to form the hydrogen gas at the fuel electrode 320 and form the oxygen gas at the air electrode 310.

A method of manufacturing a solid oxide cell according to another aspect includes forming a fuel electrode, forming a solid oxide electrolyte on the fuel electrode, and forming an air electrode on the solid oxide electrolyte.

The fuel electrode is formed by coating the surface of nickel oxide (NiO) particles with a heterogeneous metal alloyable therewith, and casting a composition for forming a fuel electrode including nickel oxide particles coated with the heterogeneous metal into, for example, a sheet shape, and then firing the same.

Here, the heterogeneous metal is not particularly limited as long as it can be reduced and form an alloy with nickel, but it is more desirable if it is a metal that can be more distributed in the particle surface region after alloying. For example, the heterogeneous metal may include tin (Sn), indium (In), bismuth (Bi), gallium (Ga), or a combination thereof.

A method of coating the surface of a nickel oxide particle with a heterogeneous metal alloyable therewith may be a sputtering method, an atomic layer deposition (ALD) method, a physical vapor deposition (PVD) method, or a chemical vapor deposition method (CVD) method.

For example, when tin (Sn) is coated on the surface of the nickel oxide particles by a sputtering method, contraction of the nickel (Ni) is delayed during firing of the fuel electrode so that it is widely distributed without aggregation. Through this, a density of the three-phase boundary of the fuel electrode may be increased. In addition, at this time, tin (Sn) is reduced to form an alloy with nickel (Ni), but tin (Sn) is mainly distributed in the surface region of the alloy oxide particles. As a result, when the solid oxide cell is driven, deterioration caused by aggregation of nickel may be prevented and durability may be improved.

The composition for forming the fuel electrode may further include a solid oxide electrolyte material. Since the description of the solid oxide electrolyte material is the same as described above, a repetitive description will be omitted. In addition, the composition for forming the fuel electrode may optionally further include a dispersant, a plasticizer, a binder, or a solvent, and may be in the form of a slurry, paste, or dispersion.

The composition for forming the fuel electrode may be cast into a sheet shape using a wet method, for example, a dipping method, a coating method, a printing method, or a spray method.

For example, firing may be performed at a temperature of 1000° C. to 1500° C., for example, 1300° C. to 1500° C., or 1400° C. to 1450° C., in an air atmosphere. However, the method of manufacturing the solid oxide cell according to this aspect is not limited thereto, and the fuel electrode may be fired together with the solid oxide electrolyte after forming the solid oxide electrolyte.

The solid oxide electrolyte may be prepared, for example, by casting a composition for forming a solid oxide electrolyte into a sheet shape on a fuel electrode and then firing it.

The composition for forming the solid oxide electrolyte may include a solid oxide electrolyte material. Since the description of the solid oxide electrolyte material is the same as described above, a repetitive description will be omitted. In addition, the composition for forming the solid oxide electrolyte may optionally further include a dispersant, a plasticizer, a binder, or a solvent, and may be in the form of a slurry, paste, or dispersion.

The composition for forming the solid oxide electrolyte may be cast into a sheet shape using a wet method, for example, a dipping method, a coating method, a printing method, or a spray method.

For example, firing may be performed at a temperature of 1000° C. to 1500° C., for example, 1300° C. to 1500° C., or 1400° C. to 1450° C., in an air atmosphere.

The air electrode may be manufactured by using a composition for forming an air electrode, for example, by casting it into a sheet shape on a solid oxide electrolyte and then firing the same.

The composition for forming the air electrode may include an air electrode material and a solid oxide electrolyte material. Since descriptions of the air electrode material and the solid oxide electrolyte material are the same as those described above, repetitive descriptions will be omitted. In addition, the composition for forming the air electrode may optionally further include a dispersant, plasticizer, binder, or solvent, and may be in the form of a slurry, paste, or dispersion.

The composition for forming the air electrode may be cast into a sheet shape on a solid oxide electrolyte by using a wet method, for example, a dipping method, a coating method, a printing method, or a spray method.

For example, firing may be performed at a temperature of 1000° C. to 1500° C., for example, 1300° C. to 1500° C., or 1400° C. to 1450° C., in an air atmosphere.

In the above, it is described to form the solid oxide electrolyte on the fuel electrode and sequentially, form the air electrode on the solid oxide electrolyte, but the method of manufacturing a solid oxide cell according to the present aspect is not limited thereto, but the fuel electrode, the air electrode, and the solid oxide electrolyte may be respectively formed and then, stacked, or after forming the solid oxide electrolyte on the air electrode, the fuel electrode may be sequentially formed on the solid oxide electrolyte.

In addition, although it is described that the firing is respectively included after forming the fuel electrode, after forming the solid oxide electrolyte, and after forming the air electrode, the method of manufacturing a solid oxide cell according to the present aspect is not limited thereto, but the firing may be performed all at once after forming the solid oxide electrolyte on the fuel electrode and then, forming the air electrode on the solid oxide electrolyte, or the solid oxide electrolyte may be formed on the fuel electrode and then, fired together, and the air electrode may be formed thereon and then, fired all together.

Hereinafter, specific examples of the invention are presented. However, the examples described below are only intended to specifically illustrate or explain the invention, and the scope of the invention should not be limited thereto.

### Preparation Example: Manufacture of Solid Oxide Cell

### (Example 1)

1) Manufacturing Nickel Oxide Particles (SnO₂@NiO) Coated with Heterogeneous Metal

0.1 g to 2 g of tin nitride based on 100 g of nickel oxide particles is dissolved in water and well dispersed therein. Subsequently, the water is completely dried at 100° C., preparing powder.

When an electrode is manufactured with this powder, SnO₂ is formed on the NiO surface after the firing, but two metals of Ni and Sn are reduced therefrom into metals during the reduction process and become an alloy. When the alloy is formed, Sn elements are more distributed on the surface of Ni than inside the Ni.

### 2) Manufacture of Solid Oxide Unit Cell

50 g of tin-coated nickel oxide particles (SnO₂@NiO), 50 g of YSZ powder, and 1.5 g of a dispersant are added to 200 g of ethanol and then, ball-milled for 24 hours. Then, 7 g of a 10 wt % polyvinylbutyral ethanol solution and 40 g of a binder solution (Kceracell Co., Ltd.) are added thereto and then, ball-milled again for 24 hours, obtaining SnO₂@NiO/YSZ dispersion.

Subsequently, a fuel electrode support attached with a film on the bottom surface is immersed in the SnO₂@NiO/YSZ dispersion for 1 minute and lifted up at a predetermined speed at room temperature and then, dried for about 5 minutes. Herein, a 10 μm-thick SnO₂@NiO/YSZ fuel electrode layer is formed on the upper surface of the fuel electrode support not attached with a film.

100 g of YSZ powder and 1.2 g of a dispersant are added to 300 g of ethanol and then, ball-milled for 24 hours. 11 g of a 10 wt % polyvinylbutyral ethanol solution and 40 g of a binder solution (Kceracell Co., Ltd.) are added thereto and then, ball-milled again for 24 hours, obtaining YSZ dispersion. The fuel electrode support attached with the SnO₂@NiO/YSZ fuel electrode layer is immersed in YSZ dispersion for 2 seconds, lifted up at a predetermined speed, dried at room temperature for about 5 minutes, and heat-treated by firing at 1300° C., forming a 2 μm-thick YSZ electrolyte on the SnO₂ @NiO/YSZ fuel electrode layer.

12 g of YSZ powder and 12 g of LSCF (La_{0.6}Sr_{0.4}Co_{0.2} Fe_{0.8}O₃) powder are added to 12 g of ethanol and then, ball-milled for 24 hours. 4 g of a 10 wt % polyvinylbutyral ethanol solution and 20 g of a binder solution (Kceracell Co., Ltd.) are added thereto and then, ball-milled again for 24 hours, obtaining YSZ/LSCF slurry. The YSZ/LSCF slurry is screen-printed on the YSZ electrolyte layer of the fired half cell and dried in an oven 60° C. for 3 hours, forming a 15 μm-thick GDC/LSCF air electrode layer. Subsequently, the product is fired at 1050° C. in a high temperature furnace under air atmosphere for 2 hours, completing a unit cell.

### (Comparative Example 1)

A unit cell is manufactured in the same manner as in Example 1 except that nickel oxide particles (NiO) not coated with a heterogeneous metal are used instead of the nickel oxide particles coated with the heterogeneous metal (SnO₂@NiO).

### Experimental Example 1: Analysis Result of Alloy Oxide Particle

In the solid oxide cell of Example 1, the alloy oxide particles included in the fuel electrode are EDS analyzed, and the results are shown in FIGS. 4 to 6 and summarized in Table 1.

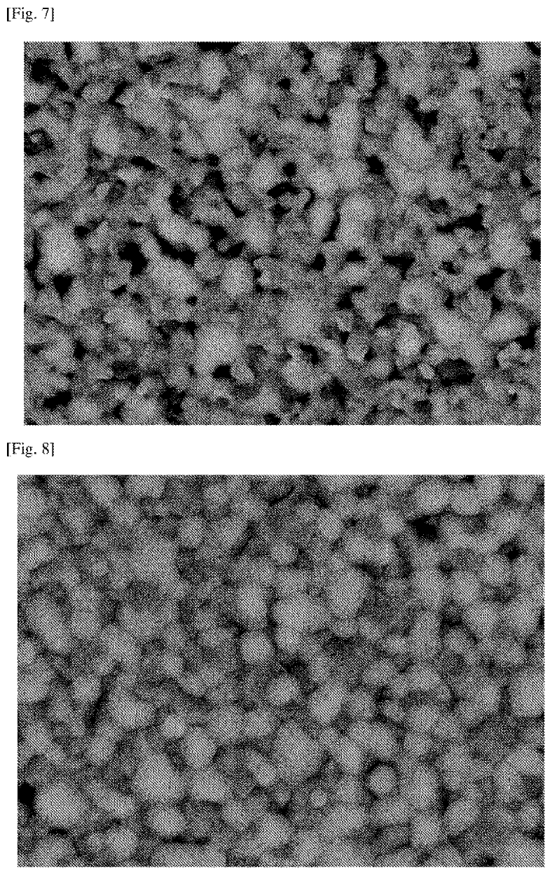

FIG. 4 is a HAADF phase of alloy oxide particles, FIG. 5 is an EDS mapping result for nickel (Ni), and FIG. 6 is an EDS mapping result for tin (Sn). In FIGS. 4 to 6, Box No. 1 indicates a center region location of the alloy oxide particles, and Box No. 2 indicates a surface region location of the alloy oxide particle.

TABLE 1

| | Center region of alloy | Surface region of alloy |
|---|---|---|
| Atom | oxide particle (at %) | oxide particle (at %) |
| O | 5.3 | 69.6 |
| Ni | 94.3 | 22.8 |
| Sn | 0.4 | 7.6 |

Referring to FIGS. 4 to 6 and Table 1, at % of tin (Sn) to all atoms in the surface region of the alloy oxide particle is larger than at % of tin (Sn) to all atoms in the center region of the alloy oxide particle, for example, about 19 times or higher.

### Experimental Example 2: Performance Measurement of Solid Oxide Cell

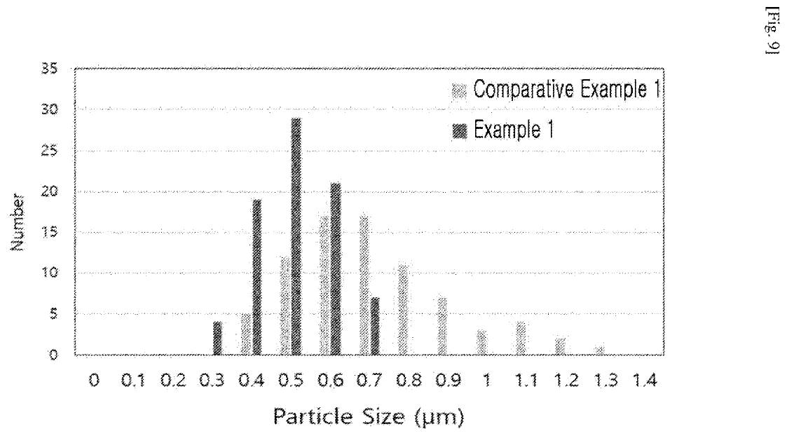

In the solid oxide cells of Example 1 and Comparative Example 1, scanning electron microscope (SEM) photographs of the fuel electrodes are respectively shown in FIGS. 7 and 8 (BED-C, 15.00 kV, WD, 10.1 mm, ×10.0 k). In FIGS. 7 and 8, a bright part is YSZ, and a dark part is an alloy oxide particle or a nickel oxide particle.

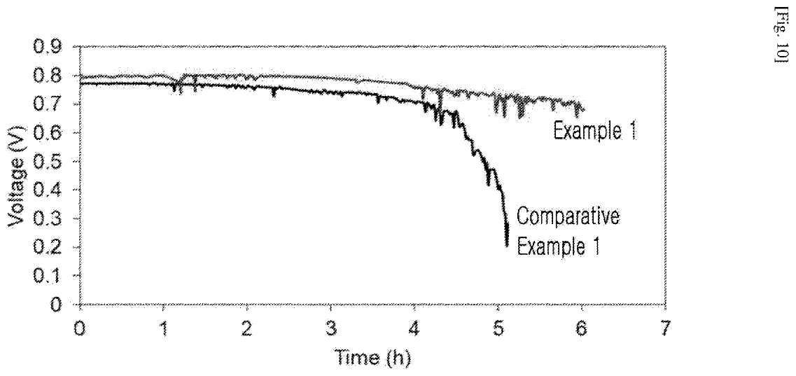

In addition, FIG. 9 shows each size distribution of the alloy oxide particles of FIG. 7 and the nickel oxide particles of FIG. 8.

Referring to FIGS. 7 to 9, the solid oxide cell of Example 1 has a smaller particle distribution (average 500 nm) due to delayed shrinkage during the curing than the nickel oxide particle distribution (average 700 nm) of Comparative Example 1.

In addition, the solid oxide cells of Example 1 and Comparative Example 1 are measured with respect to acceleration durability against to carbon contamination by injecting 100% methane gas instead of the hydrogen into the fuel electrodes, and the results are shown in FIG. 10.

Referring to FIG. 10, as a result of evaluating the acceleration durability by supplying the methane instead of the hydrogen, the solid oxide cell of Comparative Example 1 does not last more than four and a half hours, but the solid oxide cell of Example 1 lasts 6 hours or more, confirming high durability.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: solid oxide cell
110: fuel electrode
111: alloy oxide particles
112: solid oxide electrolyte material
120: air electrode
130: solid oxide electrolyte
200: solid oxide fuel cell
210: fuel electrode
220: air electrode
230: solid oxide electrolyte
300: solid oxide solid oxide electrolyzer cell
310: air electrode
320: fuel electrode
330: solid oxide electrolyte
340: external power source

### INDUSTRIAL APPLICABILITY

This disclosure relates to a solid oxide cell and a method of manufacturing the same.

According to the solid oxide cell according to one aspect, by delaying a contraction of nickel (Ni) during firing of the fuel electrode so that it is widely distributed without aggregation, a density of the three-phase boundary is increased to improve performance and by preventing deterioration occurring during fuel electrode operation, durability may be increased.

1. A solid oxide cell, comprising:
a solid oxide electrolyte; and
a fuel electrode disposed on one side of the solid oxide electrolyte and
an air electrode disposed on the other side thereof,
wherein the fuel electrode includes an alloy oxide particle of nickel (Ni) and a heterogeneous metal alloyable therewith, and a solid oxide electrolyte material, and
10×M_{core}<M_{surface}, in which M_{core} is an atomic percentage (at %) of the heterogeneous metal to all atoms in a center region of the alloy oxide particle, and M_{surface} is an atomic percentage (at %) of the heterogenous metal to all atoms in a surface region of the alloy particle.

2. The solid oxide cell of claim 1, wherein
the M_{core} is the atomic percentage (at %) of the heterogeneous metal measured within the center region centered on a center of the alloy oxide particle and having dimensions of 10 nm×10 nm, and
the M_{surface} is the atomic percentage (at %) of the heterogeneous metal measured within the surface region having dimensions of 2 nm×2 nm, centered on an internal point within 20 nm from a surface toward the center of the alloy oxide particle.

3. The solid oxide cell of claim 1, wherein
in the center region of the alloy oxide particle, the heterogeneous metal is included in an amount of greater than or equal to 0.01 at % and less than 1 at % based on the total atoms.

4. The solid oxide cell of claim 1, wherein
in the surface region of the alloy oxide particle, the heterogeneous metal is included in an amount of greater than or equal to 0.1 at % and less than 10 at % based on the total atoms.

5. The solid oxide cell of claim 1, wherein
the heterogeneous metal includes tin (Sn), indium (In), bismuth (Bi), gallium (Ga), or a combination thereof.

6. The solid oxide cell of claim 1, wherein
the solid oxide electrolyte material includes an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium irconate (BaZrO₃), a samaria- and ceria-doped barium cerate (BaCeO₃), or a combination thereof.

7. The solid oxide cell of claim 1, wherein
the solid oxide electrolyte includes an yttria-stabilized zirconia (YSZ),
a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

8. The solid oxide cell of claim 1, wherein
the air electrode includes a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

9. The solid oxide cell of claim 1, wherein
the solid oxide cell is a solid oxide fuel cell (SOFC), a solid oxide electrolyzer cell (SOEC), or both.

10. A method of manufacturing a solid oxide cell, comprising
coating a surface of a nickel oxide (NiO) particle with a heterogeneous metal alloyable therewith; and
forming a fuel electrode using a composition for forming a fuel electrode including the nickel oxide particle coated with the heterogeneous metal.

11. The method of claim 10, wherein
the coating of the heterogeneous metal on the surface of the nickel oxide (NiO) particle uses a spultering method, an atomic layer deposition (ALD) method, a physical vapor deposition (PVD) method, or a chemical vapor deposition method (CVD) method.

12. The method of claim 10, wherein
the composition for forming the fuel electrode further includes a solid oxide electrolyte material.

13. The method of claim 10, wherein
the forming of the fuel electrode includes casting and firing the composition for forming the fuel electrode.

14. A solid oxide cell, comprising:
a solid oxide electrolyte; and
a fuel electrode disposed on one side of the solid oxide electrolyte and
an air electrode disposed on the other side thereof,
wherein the fuel electrode includes a solid oxide electrolyte material,
and an alloy oxide particle of nickel (Ni) and a heterogeneous metal alloyable therewith disposed mainly in a surface region of the alloy oxide particle of nickel (Ni), and
the heterogeneous metal includes tin (Sn), indium (In), bismuth (Bi), gallium (Ga), or a combination thereof.

15. The solid oxide cell of claim 14, wherein
the surface region of the alloy oxide particle of nickel (Ni) is a region having dimensions of 2 nm×2 nm, centered on an internal point within 20 nm from a surface toward a center of the alloy oxide particle of nickel (Ni).

16. The solid oxide cell of claim 14, wherein
in a center region of the alloy oxide particle, the heterogeneous metal is included in an amount of greater than or equal to 0.01 at % and less than 1 at % based on the total atoms, and
wherein the center region of the alloy oxide particle of nickel (Ni) is a region centered on a center of the alloy oxide particle of nickel (Ni) and having dimensions of 10 nm×10 nm.

17. The solid oxide cell of claim 14, wherein
in the surface region of the alloy oxide particle, the heterogeneous metal is included in an amount of greater than or equal to 0.1 at % and less than 10 at % based on the total atoms.

18. The solid oxide cell of claim 14, wherein
the solid oxide electrolyte material includes an yttria-stabilized zirconia (YSZ), a scandia-stabilized zirconia (ScSZ), a gadolinia-doped ceria (GDC), a samaria-doped ceria (SDC), a sirontium- and magnesium-doped lanthanum gallate (LSGM), a samaria- and ceria-doped barium zirconate (BaZrO₃), a samaria- and ceria-doped barium cerate (BaCeO₃), or a combination thereof.

19. The solid oxide cell of claim 14, wherein
the solid oxide electrolyte includes an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCcO₃), or a combination thereof.

20. The solid oxide cell of claim 14, wherein
at % of the heterogeneous metal to all atoms in the surface region of the alloy oxide particle is 19 times or higher at % of the heterogeneous metal to all atoms at a center region of the alloy oxide particle.
